(19) United States
(12) Patent Application Publication
(10) Pub. No.: US 2015/0068876 A1
(43) Pub. Date: Mar. 12, 2015

(54) COMBINATION SWITCH

(71) Applicant: Yazaki Corporation, Tokyo (JP)

(72) Inventor: Shuhei URAKAMI, Makinohara-shi (JP)

(73) Assignee: YAZAKI CORPORATION, Tokyo (JP)

(21) Appl. No.: 14/480,940

(22) Filed: Sep. 9, 2014

(30) Foreign Application Priority Data
Sep. 12, 2013 (JP) 2013-188934

(51) Int. Cl. B60R 16/00; H01H 89/00

(52) U.S. Cl. CPC B60R 16/005; H01H 89/00; H01H 2235/01
USPC 200/7

(57) ABSTRACT

In a combination switch, cams having concave and convex surfaces are provided on an opposing surface of a disk-shaped opposing wall that faces a fog switch knob in the axial direction in the inside of a fixed knob. An elastic contact mechanism is provided at a part of the fog switch knob that faces the fixed knob to come into elastic contact with the concave and convex surfaces to hold an operation position of the fog switch knob. The inside of the elastic contact mechanism is filled with grease. The opposing surface of the fixed knob and the concave and convex surfaces and the outer peripheral surfaces of the cams are formed in a minor surface state with a surface roughness lower than the surface roughness of the other general parts.

### CROSS-REFERENCE TO RELATED APPLICATIONS

The present application claims priority to and incorporates by reference the entire contents of Japanese Patent Application No. 2013-188934 filed in Japan on Sep. 12, 2013.

### BACKGROUND OF THE INVENTION

1. Field of the Invention

The present invention relates to a combination switch disposed, for example, on the side of the steering column of a vehicle for use in switching the headlight and others.

2. Description of the Related Art

A variety of combination switches, for example, provided at the steering columns of automobiles are conventionally available. One of the combination switches known is described in Japanese Patent Application Laid-open No. 2012-221665.

As illustrated in FIG. 4, this combination switch includes a not-shown box-shaped switch case fixed to the side of a steering column and an operation lever 1 having a base end pivotally supported in the inside of the switch case so as to be swingable and a free front end provided with an operation unit 2. The operation unit 2 has a disk-shaped fixed member 3 disposed at a predetermined position in an axial direction. A light switch knob 4 is disposed at the front end of the operation unit 2 with the fixed member 3 interposed. A fog switch knob 5 is disposed at the base end of the operation unit 2.

As illustrated in FIG. 5, the fixed member 3 includes a cylindrical inner tube 3b integrally provided approximately at the central position on the front end surface of a disk-shaped opposing wall 3a facing the fog switch knob 5 and a pair of cams 3c integrally formed to project radially on the outer peripheral side of the inner tube 3b. A lever member 6 is inserted in the inner tube 3b. The cams 3c are each formed in an arc wall shape and each have a concave and convex cam surface 3d at the front end thereof. A cylindrical blocking wall 3e is integrally provided on the outside of the cams 3c on the opposing wall 3a of the fixed member 3.

The fog switch knob 5 includes a cylindrical section 5b integrally provided on the inner periphery of a disk-shaped fixed wall 5a integrally provided inside and an outer tube 5c on the outer periphery. The lever member 6 is inserted in the cylindrical section 5b. The outer tube 5c is disposed to be fitted on the outer peripheral surface of the blocking wall 3e. A pair of elastic contact mechanisms 7 is provided on the inner periphery of the fixed wall 5a. Each elastic contact mechanism 7 includes a tubular holder 7a, a metal ball 7b disposed in the front end opening of the holder 7a in abutment with the cam surface 3d, and a coil spring 7c resiliently set in the inside of the holder 7a to bias the ball 7b in the direction of the cam surface 3d. The inside of each holder 7a is filled with grease 8 for keeping good rolling motion of the ball 7b.

When the fog switch knob 5 is turned arbitrarily, the ball 7b in each elastic contact mechanism 7 comes into elastic contact with the concave and convex surface of each cam surface 3d by the spring force of the coil spring 7c to hold the operation position at a concave surface position and, for example, switch on and off the fog lamp.

In the conventional combination switch described above, the grease 8 in each holder 7a may be liquefied over repeated turning operations of the fog switch knob 5 to leak from the gap at the ball 7b to the outside and onto the outer surface of the operation unit 2, as illustrated by the arrow in FIG. 5.

The cylindrical blocking wall 3e is therefore provided on the outside of the cams 3c on the opposing wall 3a of the fixed member 3 as described above thereby to increase the length of the leakage path of the grease 8 like a labyrinth. This labyrinth effect suppresses the leakage of the grease 8 to the outside of the combination switch.

The conventional technique described above, provides the cylindrical blocking wall 3e on the outer periphery of the fixed member 3 in order to block leakage of the grease 8. However, the provision of the blocking wall 3e is not sufficient for blocking the leakage of the grease 8.

Moreover, the outer diameter of the operation unit 2 is inevitably increased because the outer tube 5c of the fog switch knob 5 is disposed to be fitted on the outer peripheral side of the blocking wall 3e.

### SUMMARY OF THE INVENTION

The present invention is devised in view of the technical problems of the conventional combination switch and aims to provide a combination switch that can effectively block leakage of grease to the outside without increasing the outer diameter of the operation unit.

It is an object of the present invention to at least partially solve the problems in the conventional technology.

According to one aspect of the present invention, a combination switch includes a fixed member provided in an operation unit of an operation lever, an operation knob disposed adjacent to the fixed member and having a plurality of switch positions, a cam having a concave and convex cam surface on an opposing surface of the fixed member that faces the operation knob in an axial direction; and an elastic contact mechanism provided at a part of the operation knob that faces the fixed member, the elastic contact mechanism coming into elastic contact with the cam surface to hold an operation position of the operation knob, inside of the elastic contact mechanism being filled with grease. The opposing surface of the fixed member and the surface of the cam are formed in a mirror surface state with a surface roughness higher than surface roughness of other general parts.

According to another aspect of the present invention, the fixed member and the cam are integrally formed of a synthetic resin material, and a mirror surface section including the opposing surface of the fixed member and the surface of the cam is formed from a cavity inner surface in a mirror surface state of a die for molding the resin.

According to still another aspect of the present invention, the cam projects in a direction of the elastic contact mechanism at approximately center of the opposing surface of the fixed member, and the opposing surface is flat as a whole.

According to still another aspect of the present invention, the elastic contact mechanism includes a tubular holder provided inside the operation knob, a detent member movably arranged in a front end opening of the holder, and a spring member accommodated inside the holder for biasing the detent member in a direction of the cam surface.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a fixed member for use in an embodiment of a combination switch according to the present invention;

FIG. 2 is an exploded perspective view of a main part of the combination switch of the present embodiment;

FIG. 3 is a longitudinal sectional view of the main part of the combination switch of the present embodiment;

FIG. 4 is a perspective view of a conventional combination switch; and

FIG. 5 is a cross-sectional view along line A-A in FIG. 4.

### DETAILED DESCRIPTION OF THE PREFERRED EMBODIMENTS

An embodiment of a combination switch according to the present invention will be described below with reference to the figures. This embodiment is applied to a combination switch provided on the side of the steering column of an automobile for, for example, use in switching the kinds of lights such as a headlight and a fog lamp or turning on/off the lights.

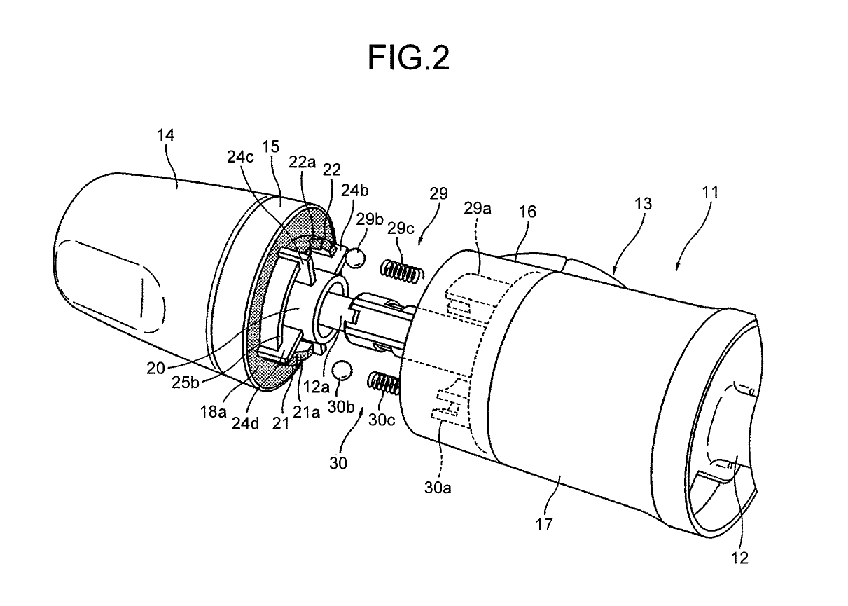

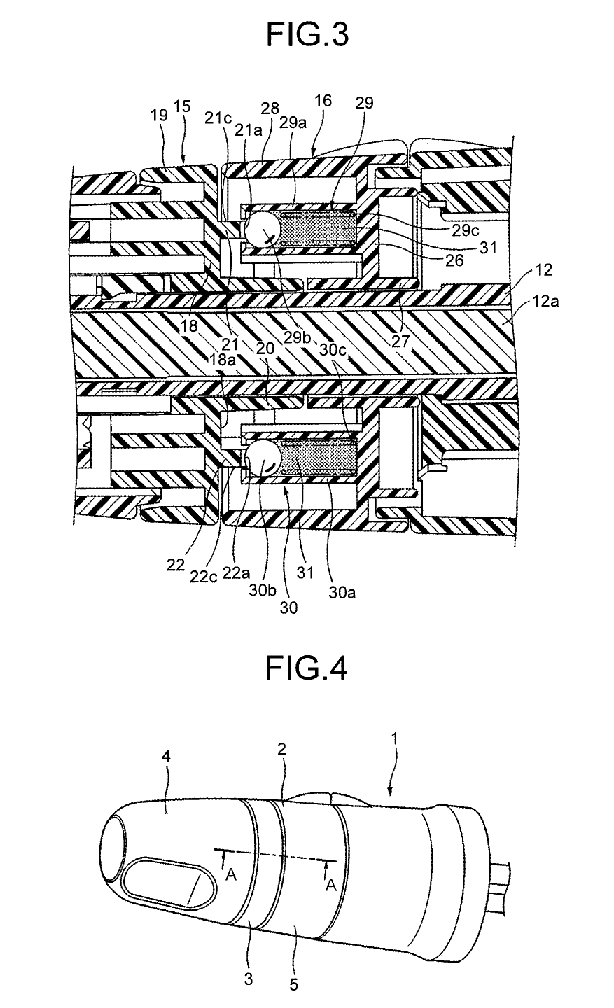

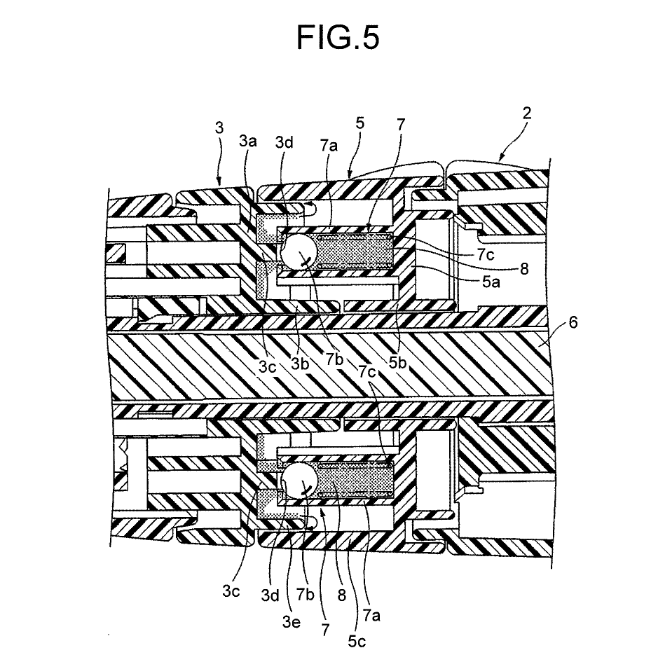

As illustrated in FIG. 2 and FIG. 3, the combination switch includes a not-shown box-shaped switch case fixed to the side of a not-shown steering column and an operation lever 11 having a base end pivotally supported in the inside of the switch case so as to be swingable and a free front end provided with an operation unit 13.

The operation lever 11 includes a tubular lever member 12 made of a synthetic resin material in an inner axial direction and the operation unit 13 provided on the outer periphery of a small-diameter lever portion 12a coupled to the front end of the lever member 12. The operation lever 11 is swung as a whole on a support point in the switch case through the lever member 12, whereby a movable switch member in the switch case is displaced to allow switch operations such as switching turn signals and headlight illumination directions. The lever member 12 has one end engaged with a not-shown movable contact member on the switch case side and the other end extending into a light switch knob 14 described later.

The operation unit 13 is fitted in the switch case at a base end side (base portion) thereof in the longitudinal direction and has, at a front end side thereof, the light switch knob 14, a fixed knob 15, which is a fixed member adjacent to the light switch knob 14 in the axial direction, a fog switch knob 16, which is an operation knob adjacent to the light switch knob 14 on the other side with the fixed knob 15 interposed, and a cover knob 17 adjacent to the fog switch knob 16. The light switch knob 14, the fixed knob 15, the fog switch knob 16, and the cover knob 17 have a common axial center. The knobs 14, 15, 16, 17 are each formed of a synthetic resin material with an injection molding machine.

Turning the light switch knob 14 turns the lever member 12 to operate the movable contact member on the switch case side so that the tail light, the small light, and the headlight are switched on and off.

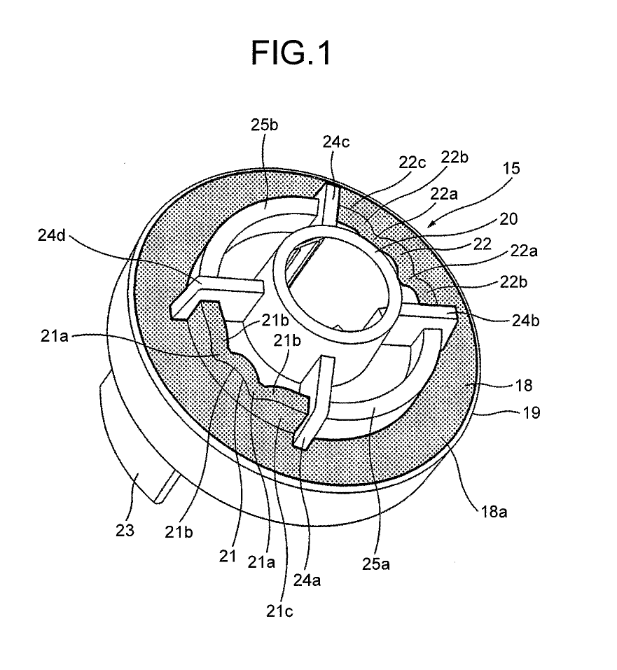

As illustrated in FIG. 1 to FIG. 3, the fixed knob 15 includes a disk-shaped opposing wall 18 facing the inside of the fog switch knob 16, an outer tube 19 integrally provided on the outer peripheral edge of the opposing wall 18, a cylindrical inner tube 20 integrally provided at the inner peripheral center position of the opposing wall 18, and a pair of arc wall-shaped cams 21, 22. The lever member 12 is inserted in the inner tube 20. The cams 21, 22 are arranged radially on the outer peripheral side of the inner tube 20 on an opposing surface 18a of the opposing wall 18 on the fog switch knob 16 side to project toward the inside of the fog switch knob 16. On the back surface opposite to the opposing surface 18a of the opposing wall 18, a pair of arch-shaped guide walls 23 pivotally guiding the light switch knob 14 is integrally provided to project at a position of 180° in the circumferential direction.

On both sides of the cams 21, 22, four rectangular first reinforcing ribs 24a to 24d are integrally provided. A pair of arc-shaped second reinforcing ribs 25a, 25b is integrally provided between the first reinforcing ribs 24a and 24b and between 24c and 24d, and their ends are integrally coupled.

The cam 21, 22 has two concave surfaces 21a, 22a and three convex surfaces 21b, 22b as a cam surface at the front end.

As illustrated in FIG. 3, the fog switch knob 16 includes a cylindrical section 27 integrally provided on the inner periphery of a disk-shaped fixed wall 26 provided inside and an outer tube 28 integrally provided on the outer periphery to face the outer tube 19 of the fixed knob 15 in the axial direction. The lever member 12 is inserted in the cylindrical section 27. A pair of elastic contact mechanisms 29, 30 is provided on the inner periphery of the fixed wall 26. The elastic contact mechanism 29, 30 includes a tubular holder 29a, 30a, a metal ball 29b, 30b disposed in the front end opening of the holder 29a, 30a in abutment with the concave and convex surfaces 21a, 22a, 21b, 22b, and a coil spring 29c, 39c resiliently set in the inside of the holder 29a, 30a to bias the ball 29b, 30b in the direction of the concave and convex surfaces 21a to 22b. The inside of the holder 29a, 30a is filled with grease 31 for keeping good rolling motion of the ball 29b, 30b.

When the fog switch knob 16 is turned arbitrarily, the ball 29b, 30b of the elastic contact mechanism 29, 30 comes into elastic contact with the concave and convex surfaces 21a to 22b by the spring force of a coil spring 29c, 30c to hold the operation position at the concave surface 21a, 22a and, for example, switch on and off the fog lamp.

The opposing surface 18a of the opposing wall 18 of the fixed knob 15 and the outer peripheral surfaces 21c, 22c and the concave and convex surfaces 21a to 22b of the cams 21, 22 are formed in a mirror surface state with a surface roughness higher than the surface roughness of general parts including the first and second reinforcing ribs 24a to 24d, 25a, 25b.

More specifically, as shown by the dots in FIG. 1, the region of the mirror surface section as described above is formed throughout the entire outer peripheral section of the opposing surface 18a of the opposing wall 18 excluding the entire outer surfaces of the first and second reinforcing ribs 24a to 24d, 25a, 25b and the inside of the cams 21, 22, and entirely on the concave and convex surfaces 21a to 22b and the outer peripheral surfaces 21c, 22c of the surfaces of cams 21, 22 excluding the inner peripheral surface.

The mirror surface section including the opposing surface 18a and the surfaces of the cams 21, 22 is formed from the inner surface of the cavity formed in a mirror surface state of an injection molding die for resin molding the fixed knob 15.

The surface roughness of the mirror surface section is set to such a roughness level that does not form minute lines or other marks on the surfaces such as the opposing surface 18a and the concave and convex surfaces 21a, 22b and the outer peripheral surfaces 21c, 22c of the cams 21, 22 and does not cause capillary action.

According to the present embodiment, even when the grease 31 in the holders 29a, 30a is liquefied over repeated turning operations of the fog switch knob 16 and leaks, though slightly, from the front end openings of the holders 29a, 30a through the outer surfaces of the balls 29b, 30b to the outside and adheres to the concave and convex surfaces 21a to 22b of the cams 21, 22 of the fixed knob 15, the leakage from the outer peripheral surfaces 21c, 22c of the cams 21, 22 to the outside can be blocked.

As previously mentioned, if the surface roughness of the opposing surface 18a and the cams 21, 22 is rough, the capillary action makes the grease 31 more likely to leak. However, the surface roughness of the opposing surface 18a, the concave and convex surfaces 21a to 22b, and the outer peripheral surfaces 21c, 22c is set high in a mirror surface state, thereby avoiding capillary action. The leakage of the liquefied grease 31 thus can be suppressed.

Even if the liquefied grease adheres to the opposing surface 18a of the opposing wall 18 through the outer peripheral surfaces 21c, 22c or other surfaces, spread and leakage can be suppressed sufficiently since the opposing surface 18a is also formed in a mirror surface state. The grease 31 thus no longer leaks onto the outer peripheral surface of the operation unit 13.

Even if the liquefied grease 31 leaks from the concave and convex surfaces 21a to 22b or the outer peripheral surfaces 21c, 22c toward the first reinforcing ribs 24a to 24d or the second reinforcing ribs 25a, 25b, the leakage from the mirror-surface opposing surface 18a to the outer peripheral side can be sufficiently suppressed.

As described above, the present embodiment eliminates the need for providing a blocking wall for blocking external leakage of grease on the outer peripheral side of the fixed knob as in the conventional example described above and may reduce the outer diameter of the fixed knob 15 as much as possible. In this case, the diameter of the operation unit 13 can be reduced as a whole.

The present invention is not limited to the configuration of the foregoing embodiment. For example, in addition to the predetermined places such as the opposing surface 18a and the cams 21, 22, for example, the surfaces of the first and second reinforcing ribs 24a to 24d, 25a, 25b may be formed in a mirror surface state.

The present invention is applicable to any part of a combination switch having a detent mechanism including the cams 21, 22 and the elastic contact mechanisms 29, 30. The combination switch is applicable to devices or instruments other than vehicles.

The mirror finish of the opposing surface 18a of the fixed knob 15 and other parts may not be necessarily provided by the cavity surface of a molding die but may be provided by predetermined polishing after molding.

The inventor of the subject application has elaborately examined the cause of the leakage of liquefied grease from the elastic contact mechanisms to the outer surface of the operation unit along the surface of the fixed member or other parts, through experiments and other means. The inventor has noted the surface roughness of the opposing surface of the fixed member and found that coarse surface roughness causes capillary action to make the liquefied grease more likely to leak.

In the present invention, the opposing surface of the fixed member and the surfaces of the cams are formed in a mirror surface state with a surface roughness higher than the surface roughness of the other general parts, thereby suppressing the capillary action at the opposing surface and the cam surface. The leakage to the outside is thus blocked effectively.

In the combination switch according to one aspect of the present invention, the combination switch can effectively block leakage of grease to the outside.

In the combination switch according to another aspect of the present invention, the combination switch facilitates the operation of forming a mirror surface section when compared with polishing after molding, because the mirror surface section including the opposing surface of the fixed member and the surfaces of the cams are formed from the cavity inner surface of a molding die.

In the combination switch according to still another aspect of the present invention, the combination switch increases the grease leakage blocking effect owing to the mirror finish, because the opposing surface is flat as a whole.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A combination switch comprising:
a fixed member provided in an operation unit of an operation lever;
an operation knob disposed adjacent to the fixed member and having a plurality of switch positions;
a cam having a concave and convex cam surface on an opposing surface of the fixed member that faces the operation knob in an axial direction; and
an elastic contact mechanism provided at a part of the operation knob that faces the fixed member, the elastic contact mechanism coming into elastic contact with the cam surface to hold an operation position of the operation knob, inside of the elastic contact mechanism being filled with grease, wherein
the opposing surface of the fixed member and the surface of the cam are formed in a minor surface state with a surface roughness lower than surface roughness of other general parts.

2. The combination switch according to claim 1, wherein the fixed member and the cam are integrally formed of a synthetic resin material, and a minor surface section including the opposing surface of the fixed member and the surface of the cam is formed from a cavity inner surface in a minor surface state of a die for molding the resin.

3. The combination switch according to claim 1, wherein the cam projects in a direction of the elastic contact mechanism at approximately center of the opposing surface of the fixed member, and the opposing surface is flat as a whole.

4. The combination switch according to claim 2, wherein the cam projects in a direction of the elastic contact mechanism at approximately center of the opposing surface of the fixed member, and the opposing surface is flat as a whole.

5. The combination switch according to claim 1, wherein the elastic contact mechanism includes a tubular holder provided inside the operation knob, a detent member movably arranged in a front end opening of the holder, and a spring member accommodated inside the holder for biasing the detent member in a direction of the cam surface.

6. The combination switch according to claim 2, wherein the elastic contact mechanism includes a tubular holder provided inside the operation knob, a detent member movably arranged in a front end opening of the holder, and a spring member accommodated inside the holder for biasing the detent member in a direction of the cam surface.

7. The combination switch according to claim 3, wherein the elastic contact mechanism includes a tubular holder provided inside the operation knob, a detent member movably arranged in a front end opening of the holder, and a spring member accommodated inside the holder for biasing the detent member in a direction of the cam surface.
